(19) United States
(12) Patent Application Publication
(10) Pub. No.: US 2026/0316305 A1
(43) Pub. Date: Oct. 15, 2026

(54) COUNTERBALANCING LIFT-ARM ASSEMBLY

(71) Applicant: ROBRADY CAPITAL, LLC, Sarasota, FL (US)

(72) Inventors: Robert Owen BRADY, Sarasota, FL (US); Steven Douglas Macfarlane, Sarasota, FL (US); Matthew William Vergin, Sarasota, FL (US)

(21) Appl. No.: 19/297,185

(22) Filed: Aug. 12, 2025

Related U.S. Application Data
(60) Provisional application No. 63/682,049, filed on Aug. 12, 2024.

(51) Int. Cl. B25J 19/00; B25J 1/02; B25J 13/02; B25J 15/08

(52) U.S. Cl. CPC B25J 19/0012; B25J 1/02; B25J 13/02; B25J 15/083

(57) ABSTRACT

A counterbalancing lift-arm assembly to assist users in moving items of various weights and dimensions includes a support assembly configured to allow horizontal pivotal movements, a position adjustment assembly configured to allow vertical adjustments, and a retaining assembly for securing, retaining and releasing items. The support assembly allows a user to move the retaining assembly along the vertical plane, while the position adjustment assembly reduces physical effort required for lifting items. The position adjustment assembly may comprise pneumatic cylinders and/or springs for counterbalancing and “dead-man switches” for safety. The retaining assembly generally comprises extendable channels and corresponding retaining structures that collectively define grasping arms. The lift-arm assembly incorporates a mechanism that allows the user to selectively dispose the grasping arms in an open or expanded orientation, or in a closed or collapsed orientation to secure an intended item upon contact.

### RELATED APPLICATIONS

This application claims priority to U.S. Provisional Application Ser. No. 63/682,049 filed on Aug. 12, 2024, the contents of which are herein incorporated by reference in their entirety.

### FIELD

The present invention relates to mechanical, counterbalancing equipment intended for manually moving items from one location to another.

### BACKGROUND

Manually moving heavy or otherwise oversized items in places such as factories, warehouses, job sites, airports, and offices has long been a challenge and can sometimes pose serious risks of injuries and damage to property. Often times, such operations require physical exertion from workers, which can lead to fatigue, strain, and workplace injuries. Moreover, powerlifting tools can be cumbersome to use, involve a considerable expense, require complex installation and transport, or even lack the flexibility needed for diverse workplace settings. Manual lifting aids fail to provide a balanced approach between user control and load support. Many systems either offer inadequate support, leaving the user to bear too much of the physical load, or are overly rigid, limiting the user's ability to make precise and quick positional adjustments. Furthermore, the retention and release mechanisms of lifting devices can be cumbersome and even unreliable. Complex procedures are often required to secure and release items, while others may not adequately adapt to varying sizes and shapes of objects.

Accordingly, there is a need in the industry for a versatile, manually-operated lifting solution that can effectively counterbalance loads. The industry would benefit if such a solution would allow users to automatically and securely retain a variety of items and move them with relative ease. An even further benefit would be provided if such a device would reduce the physical strain on workers when moving items while also allowing the user to control the lifting and positioning process.

### SUMMARY

The present invention is directed to a lift-arm assembly with a counterbalancing mechanism that is designed to assist users in safely grasping, moving, positioning, and/or releasing various items of different weights in diverse environments such as factories, warehouses, job sites, airports, offices, etc. The lift-arm assembly according to the present invention generally comprises a support assembly, a position adjustment assembly and a retaining assembly. The support assembly is generally configured to allow pivotal movements and act as an arm or extension of the position adjustment assembly and the retaining assembly. The position adjustment assembly is generally configured to enable an upward and downward positional adjustment of the retaining assembly. The retaining assembly is generally intended to allow the user to automatically secure items, retain them during movement and to release them at an intended drop off location.

The support assembly includes a vertical support connected to a base, which can be attached to various surfaces such as floors, walls, tables, ceilings, structures, equipment, etc. A sleeve may be disposed around the vertical support and may be configured to slidably rotate around it. A horizontal support or swing arm may be connected to the sleeve and structured to rotate around the vertical support. Additional vertical and/or horizontal supports such as arms, braces, etc., as well as pivotal connections, horizontal members, or other components may be provided to enable a movement of the position adjustment assembly and/or the retaining assembly in various directions.

The position adjustment assembly may incorporate motion control cylinders, e.g. pneumatic cylinders, which may be structured to provide an inherent uplift force that may be adjusted according to the type of intended item that would need to be moved. This counterbalancing effect of the position adjustment assembly is intended to reduce the physical effort required by the user to move items, especially in an upward direction. One or more biasing structures may also be disposed within the position adjustment assembly to enhance this counterbalancing effect.

Features of the present invention comprise providing a lift-arm assembly with a retaining assembly that incorporates “dead-man switches” in the form of handle levers. These switches are intended to be a safety feature that allows the user to selectively enable a manual vertical movement of the position adjustment assembly. This feature is beneficial, for example, if an item falls or if the user is injured. When the levers are not pulled, the position adjustment assembly, and consequently the retaining assembly, remain in a locked position thereby preventing unintended vertical movements.

The retaining assembly consists of a housing with extendable channels with retaining structures and a locking assembly disposed therein. It is contemplated that the extendable channels may collectively define a telescopic assembly that expands and retracts within the housing. Furthermore, the retaining structures may be disposed on the outside ends of the channels to collectively define two grasping arms that extend out of the housing, and that retract into the housing to retain an item. Although two grasping arms are described herein, the present invention contemplates providing a housing with three or more grasping arms according to the need. Accordingly, the extendable channels are generally configured to move between an “open orientation” when extended and a “closed orientation” when retracted to secure items of various sizes.

The locking assembly includes a locking mechanism that generally acts as a pin to secure the extendable channels in the open orientation, but that automatically closes the extendable channels and corresponding retaining structures when the housing or portion thereof comes into contact with an item to be lifted. As contemplated herein, when an underside of the housing comes into contact with the item to be lifted, the channels and corresponding structured will close and secure the intended item. However, this is not necessarily limiting as it is contemplated that the channels and retaining structures may also close upon another portion of the housing comes into contact with the item, or through the activation of another mechanism. The retaining assembly may further incorporate visual indicators to show whether the retaining assembly is securely closed around an item, using a color scheme to guide the user and indicate when it is safe to move an item, e.g., green, or when it is unsafe, e.g., red.

The lift arm assembly according to the present invention may also be provided with a manual override feature, which may be configured to allow a user to open the retaining assembly when necessary, such as when releasing an item at its destination. This may be achieved through a rotating lever connected to an internal pin and gear system.

### BRIEF DESCRIPTION OF THE DRAWINGS

The aspects and the attendant advantages of the embodiments described herein will become more readily apparent by reference to the following detailed description when taken in conjunction with the accompanying drawings wherein:

FIG. 1 is a perspective view of a lift-arm assembly according to the present invention;

FIG. 2 is a cross-sectional view of the lift-arm assembly of FIG. 1;

FIG. 3 is a detail cross-sectional view of a retaining assembly of the lift-arm assembly;

FIG. 4 is a perspective view of the retaining assembly of FIG. 3;

FIG. 5 is a front cross-sectional view of the retaining assembly;

FIG. 6 is a perspective detail view of a portion of the retaining assembly;

FIG. 7 is a bottom cross-sectional view of a housing of the retaining assembly;

FIG. 8 is a perspective view of a position adjustment assembly of the lift-arm assembly;

FIG. 9 is a cross-sectional view of the position adjustment assembly;

FIG. 10 is a top cross-sectional view of the position adjustment assembly;

FIG. 11 is a perspective view of a base according to the support assembly and depicting a resting clip with a visual indicator;

FIG. 12 is a cross-sectional view of a portion of the retaining assembly of FIG. 3 in an open orientation;

FIG. 13 is a cross-sectional view of the portion of the retaining assembly of FIG. 3 in a closed orientation;

FIG. 14 is a cross-sectional view of a portion of the retaining assembly picking up an item;

FIG. 15 is a cross-sectional view of the portion of the retaining assembly releasing the item;

FIG. 16 is a cross-sectional view of a portion of a housing of the retaining assembly;

FIG. 17 is a cross-sectional view of a gear of the retaining assembly being rotated;

FIG. 18 is a cross-sectional view of a second vertical support of the retaining assembly depicting a release lever;

FIG. 19 is a cross-sectional view of the second vertical support of the retaining assembly depicting a release lever;

FIG. 20 is a cross-sectional view of the second vertical support of the retaining assembly depicting a release lever with an indicator showing that the retaining assembly is disposed in the open orientation; and

FIG. 21 is a cross-sectional view of the second vertical support of the retaining assembly depicting a release lever with an indicator showing that the retaining assembly is disposed in the closed orientation.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

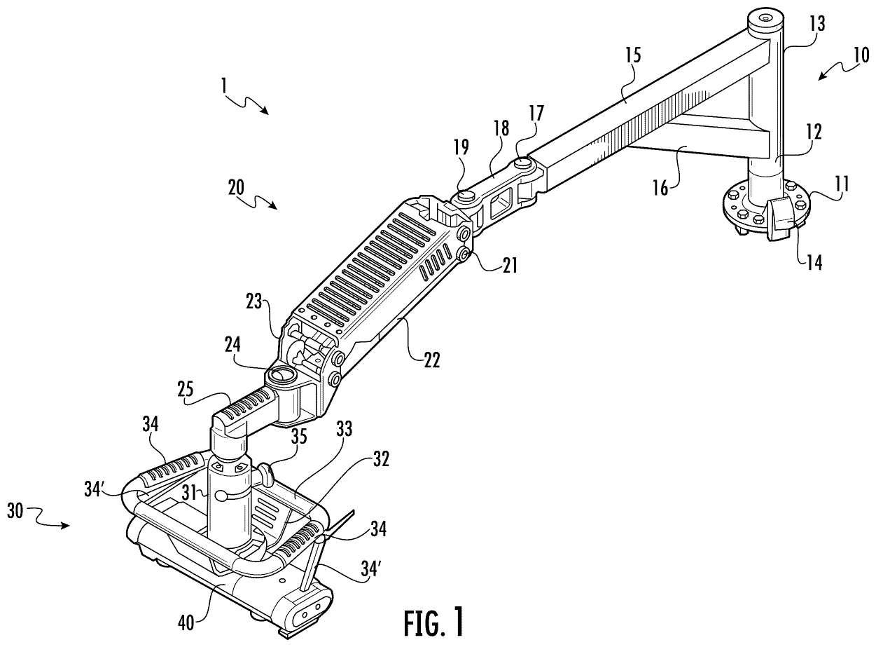

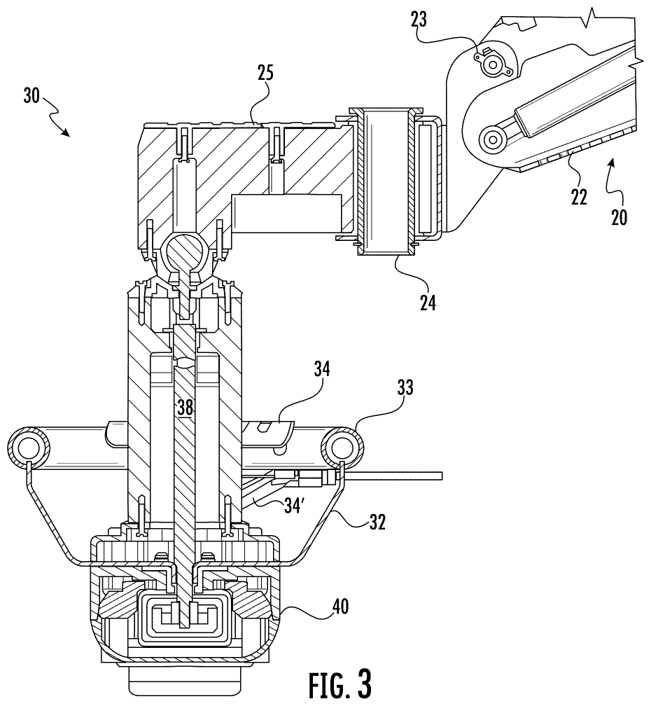

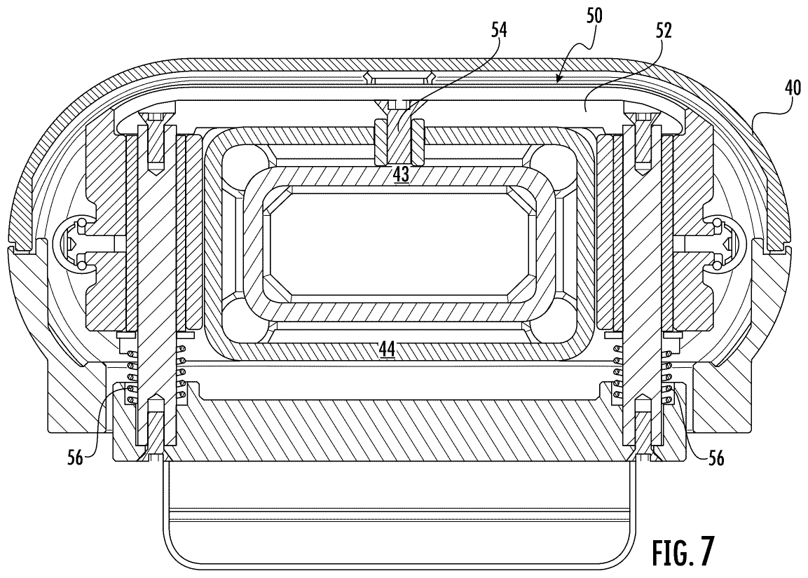

As represented in FIGS. 1-21, the present invention is directed to a mechanical, counter-balancing lift-arm assembly, which for simplicity will be referred to as a lift-arm assembly 1. The lift-arm assembly 1 according to the present invention is primarily intended to act as a counterbalancing arm system that may be manually adjusted and used by an individual to safely retain, move and release a variety of items of various weights, including, without limitation boxes, packages, battery packs as may be used in connection with drones or other equipment, luggage, equipment, materials, components, tools, etc.

As contemplated by the present invention, the lift-arm assembly 1 may be used in various locations or environments, including, without limitation, factories, warehouses, deposits, job sites, airports, seaports, storage facilities, offices, garages, workshops, farms, etc. For simplicity, the items that may be retained and/or moved by the retaining assembly 30 will be referred to as “item(s)” or “intended item(s)”. As will be explained herein, the retaining assembly 30 may be provided as an integral component of the lift-arm assembly 1. However, this is not strictly limiting as the retaining assembly 30 may be manufactured as its own standalone component.

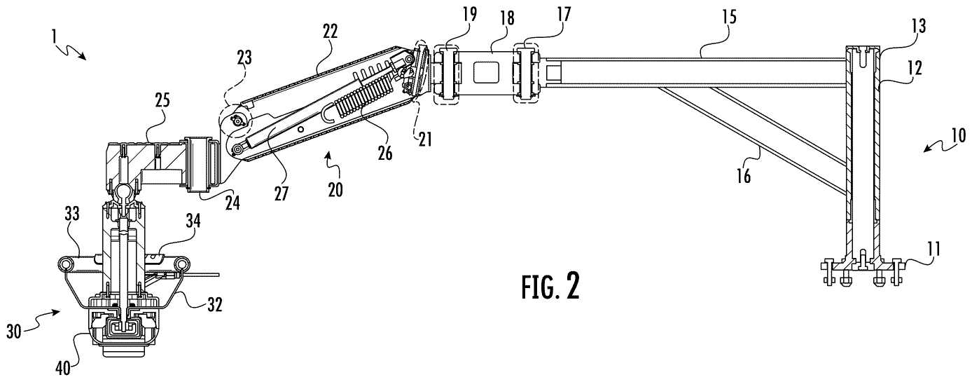

With reference to at least FIGS. 1-2, the lift-arm assembly 1 according to the present invention is generally configured to allow a user to manually hold the retaining assembly 30 and make positional adjustments of an intended item with relative ease. As contemplated by the present invention, the user should be able to exert reduced physical force on the lift-arm assembly 1 to move it. That is, the counter-balancing mechanisms of the lift-arm assembly 1 are configured to at least partially reduce the physical force that would otherwise be required by the user or human operator to manually adjust the position of the intended item(s) thereby reducing the load on the user. Accordingly, the lift-arm assembly 1 generally comprises a support assembly 10, a position adjustment assembly 20 and a retaining assembly 30.

The support assembly 10 is generally structured to allow at least a horizontal pivotal movement of the retaining assembly 30 holding the intended item(s). Further, the position adjustment assembly 20, which is operatively connected to the support assembly 10, is also configured to allow vertical positional adjustment, upward and downward, of the retaining assembly 30 holding the intended item(s).

With reference to at least FIGS. 1-2 and 11, the support 10 assembly generally comprises a first vertical support 13 operatively connected to a base 11 that may be connected to a surface such as floor, wall, table, ceiling, equipment, structure, etc. For example, the base 11 may be connected to the surface by way of bolts, screws, brackets, a snap-in mechanism, glue, epoxy, etc. A sleeve 12 is generally disposed around the first vertical support 13 and may be configured to rotate around an axis defined along the length of the first vertical support 13. Further a first horizontal support 15 or swing arm, may be connected to the sleeve 12, and as such, may be structured to pivot around the first vertical support 13. A brace 16 may be connected to both the sleeve 12 and the first horizontal support 15, e.g., for stability, and may also be structured to pivot with the first horizontal support 15 around the first vertical support 13.

As represented in FIGS. 1-2, a second horizontal support 18 may be used to interconnect the position adjustment assembly 20 to the first horizontal support 15. A first generally horizontal pivotal connection 17 may be configured to allow a generally horizontal pivotal movement between the first horizontal support 20 and the second horizontal pivotal support 18. A second horizontal pivotal connection 19 may be configured to permit a generally horizontal pivotal movement of the position adjustment assembly 20, including a housing 22 thereof, relative to the second horizontal support 18.

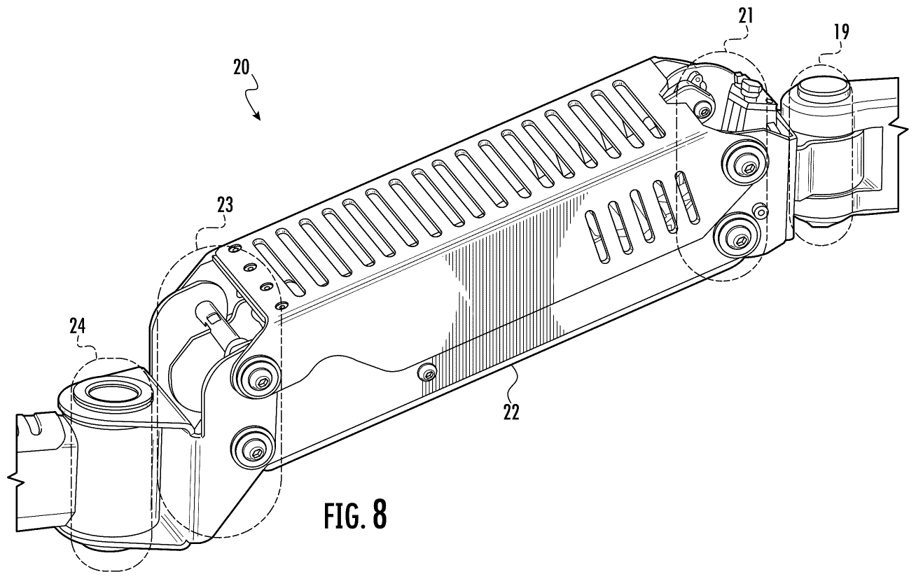

As is perhaps best appreciated from FIGS. 8-10, a first vertical pivotal connection 21 may enable a generally vertical pivotal movement of the position adjustment assembly 20, including a housing 22 thereof, relative to the second horizontal support 18. A second vertical pivotal connection 23 may be configured to permit a vertical pivotal movement of the retaining assembly 30, including a third generally horizontal support 25 thereof, relative to the position adjustment assembly 20. A third generally horizontal pivotal connection 24 may be configured to permit a generally horizontal pivotal movement of the retaining assembly 30, including a third horizontal support 25 thereof, relative to the position adjustment assembly 20. As such the foregoing pivotal connections allow the user to make a plurality of adjustments to the position of the retaining assembly 30 both in the vertical and in the horizontal direction.

The lift-arm assembly 1 according to the present invention generally comprises various components structured to allow a user to manually adjust the position of the retaining assembly 30. For example, and in addition to the foregoing pivotal connections and structural components described herein, the lift-arm assembly 1 according to the present invention contemplates incorporating counterbalancing mechanisms such as a motion control cylinder(s) 27.

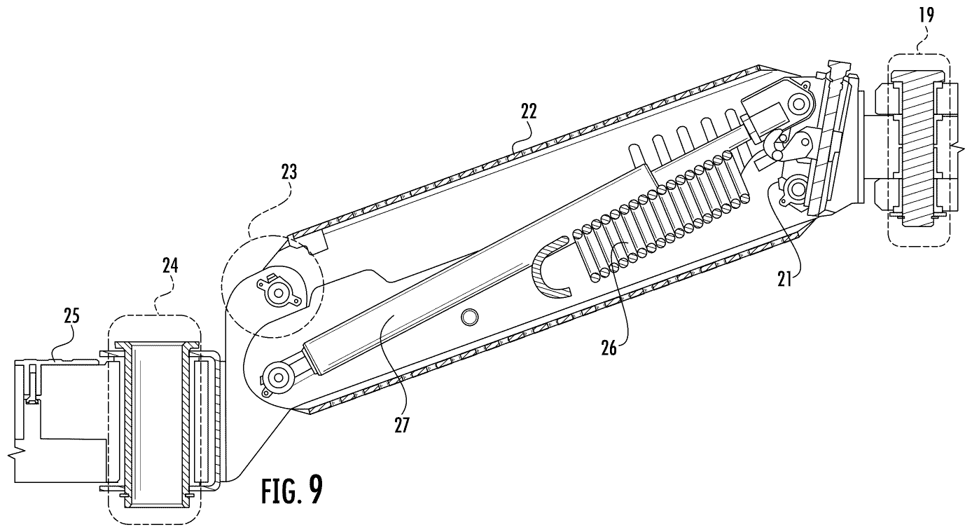

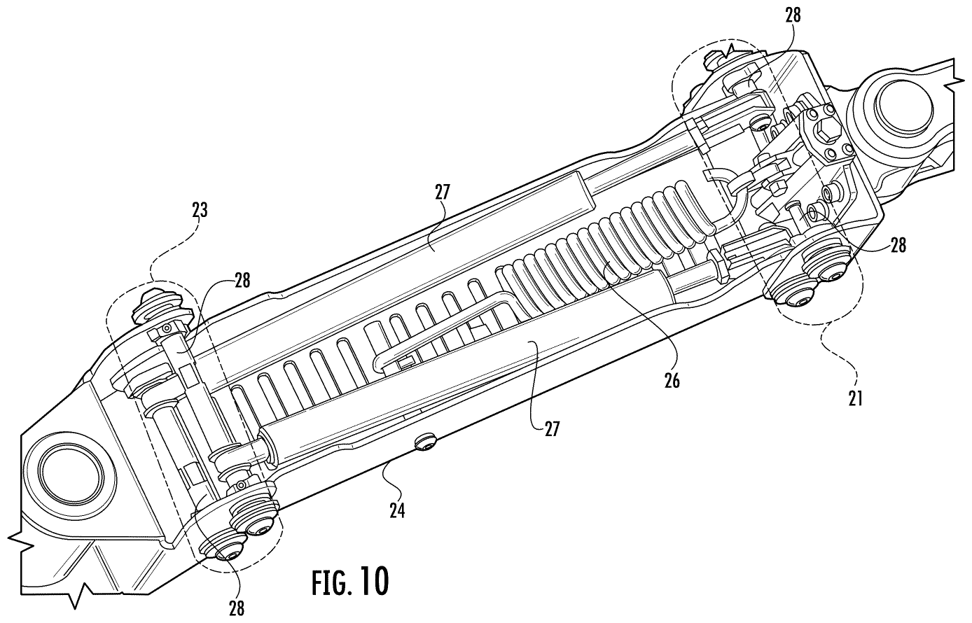

As is depicted in FIGS. 9-10, the motion control cylinder(s) 27 may be disposed on the inside of the housing 22 of the position adjustment assembly 20. By way of example, the motion control cylinder(s) 27 may comprise pneumatic motion control cylinders configured to at least partially reduce the force required to move the retaining assembly 30 and/or intended item(s) in the upward direction. Said differently, the motion control cylinder(s) 27 may be configured to provide an inherent uplift force to the position adjustment assembly 20, and consequently the retaining assembly 30. As such, the retaining assembly 30 is configured to have a tendency to naturally move in the upward direction.

In addition, as depicted in FIGS. 2, 9 and 10, one or more springs 26 may be provided as a counterbalancing mechanism to further achieve and/or enable the counterbalancing effect of the position adjustment assembly 20.

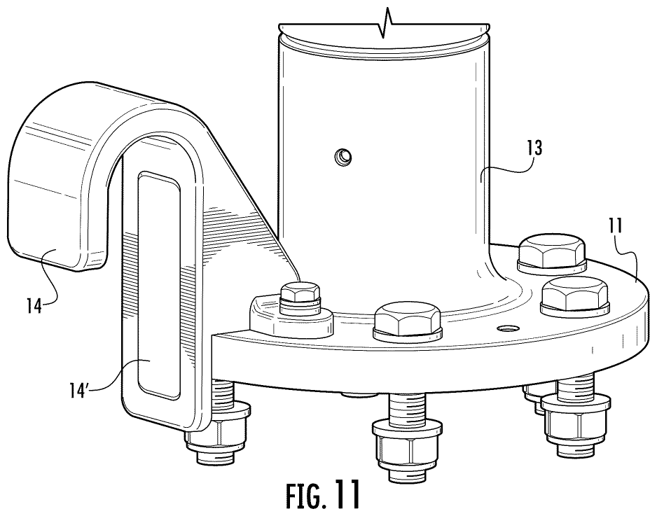

With reference not to at least FIG. 11, the lift-arm assembly 1 according to the present invention may comprise a resting clip 14 for the user to secure the retaining assembly 30 during periods of non-operation. As mentioned above the position adjustment assembly 20 generally has an inherent upward force or otherwise a natural tendency to move in the upward direction, e.g., when disposed in the free movement position. Consequently, the retaining assembly 30 will also have a tendency to move in the upward direction when the adjustment assembly 20 is disposed in the free movement position. Accordingly, the base 11 of the support assembly 10 may comprise a resting clip 14 or a comparable structure, e.g., a downward facing hook, configured and dimensioned to prevent a further upward movement of the handle bar 33 of the retaining assembly 30 and dispose it in a secured, non-movement position. The resting clip 14 is further intended to lift-arm assembly 1 from moving when it is not in operation. The resting clip 14 may also comprise a visual indicator 14′ that is exposed when the lift-arm assembly 1 is not stowed in a resting position.

As is also shown in FIG. 10, more than one motion control cylinder 27 may be provided and/or disposed at different orientations. For example, the motion control cylinders may be disposed without the housing along its length, and may be connected to different pairs of rods 28 transversely disposed with respect to the length of the housing 22 at opposite ends thereof.

As is also shown in FIG. 10, one motion control cylinder may be connected on one end to a bottom rod 28 of the second vertical pivotal connection 23, and on the other end to a top rod 28 of the first vertical pivotal connection 21. A second motion control cylinder may be connected on one end to a top rod 28 of the second vertical pivotal connection 23, and on the other end to a bottom rod 28 of the first vertical pivotal connection 21.

Although the foregoing configuration is not necessarily limiting, it may assist with enabling a counterbalancing effect of the lift-arm assembly 1 and/or to provide stability and a more compact lift-arm assembly 1. Thus, the tension of the motion control cylinder(s) 27 may be adjusted to account for the weight of the intended item and provide appropriate counterbalancing. Furthermore, the tension of the motion control cylinder(s) 27 may be configured to provide positive lock positions of the lift-arm assembly 1 and also provide for a smooth, dampened control of its movement.

As represented at least in FIGS. 1-5, additional features of the present invention comprise providing a lift-arm assembly 1 configured to enable vertical movement of the position adjustment assembly 20, and consequently the retaining assembly 30 upon a manual user activation. That is, the lift-arm assembly 1 may be provided with one or two “dead-man switches” that allow the user to selectively enable a vertical movement of the position adjustment assembly 20, for example, only upon a manual activation thereof.

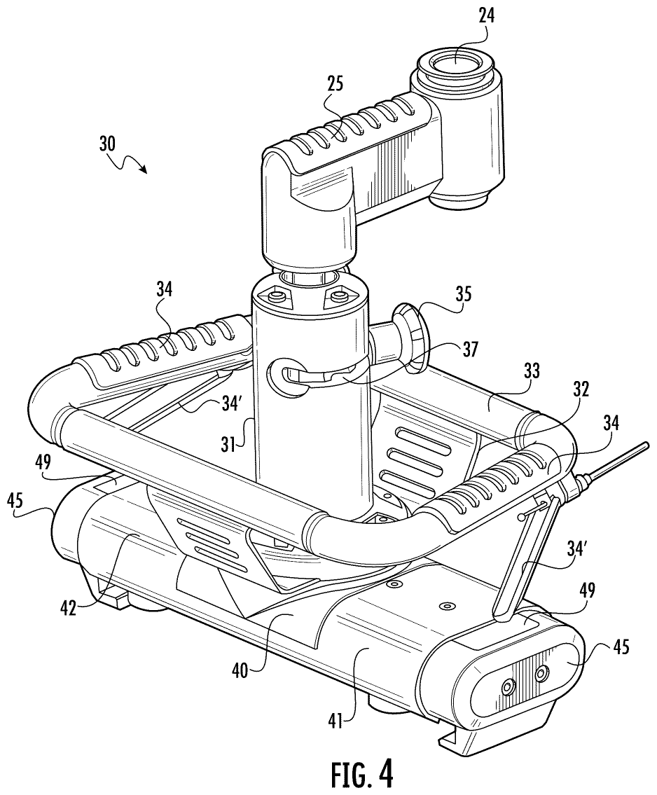

As is perhaps best shown in FIG. 4, a handle bar 33 may be interconnected to the housing 40 via one or more connecting structures 32. Two grab handles 34, each one intended for a corresponding hand of the user, may be disposed on either side of the handle bar 33, and may be configured with a texture or pattern that may facilitate a hand grip. Additionally, each of two handle levers 34′ or dead-man switches may be operatively connected to a corresponding grab handle 34, and may be operatively configured with the motion control cylinder(s) 27, e.g., with a tensioning wire or cable that selectively enables and restricts the movement or otherwise locks the motion control cylinder(s) 27.

For example, a tensioning wire or cable may be mounted to the handle bar 33 and may be routed to the position adjustment assembly 20 and/or to the motion control cylinders 27 to control their operation. As such, the user may selectively pull both handle levers 34′ to dispose the position adjustment assembly 20 into and out of a “free movement position” and a “locked position”. However, pulling on both handle levers 34′ is not strictly necessary as the lift-arm assembly 1 may be configured such that a user may pull on only one of the two handle lever 34′ to selectively dispose the position adjustment assembly 20 into and out of the free movement position and the locked position.

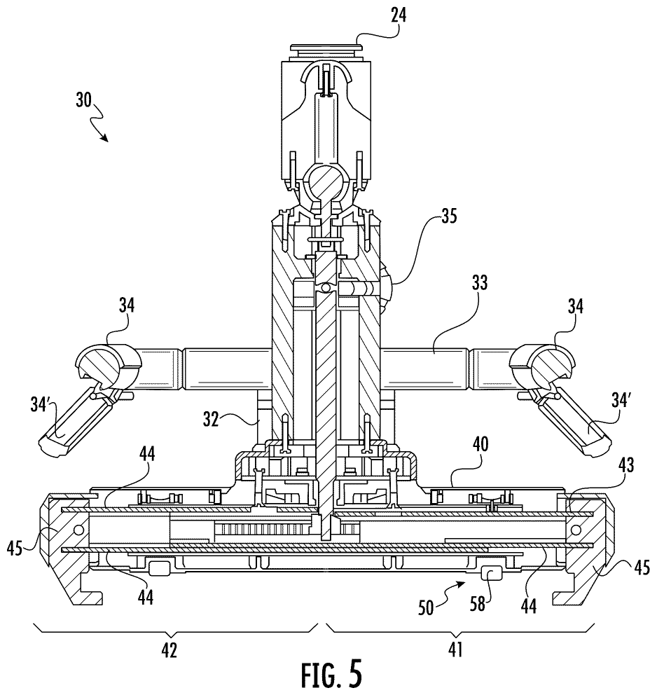

Accordingly, when the position adjustment assembly 20 is disposed into the free movement position, the user should be able to make vertical adjustments to the position of the retaining assembly 30. It is contemplated that when the handle levers 34′ are not being manually pulled towards the handle bar 33, that they remain in their natural or released position, i.e., as shown in FIGS. 4-5, thereby maintaining the position adjustment assembly 20 in the locked position.

Nonetheless, the present invention contemplates that when the position adjustment assembly 20 is disposed in the locked position, the user should still be able to make horizontal adjustments to the position of the retaining assembly 30, i.e., due to the various pivotal connections described above. As such, when either or both levers 34′ are released, i.e., not pulled towards the handle bar 33, the position adjustment assembly 20, and consequently the retaining assembly 30, will be safely held in position, which may prevent the intended item from falling, including a heavy intended item. For example, after a heavy item falls or if a user is injured, the lift-arm assembly 1 may be configured to immediately stop when either or both levers 34′ are released.

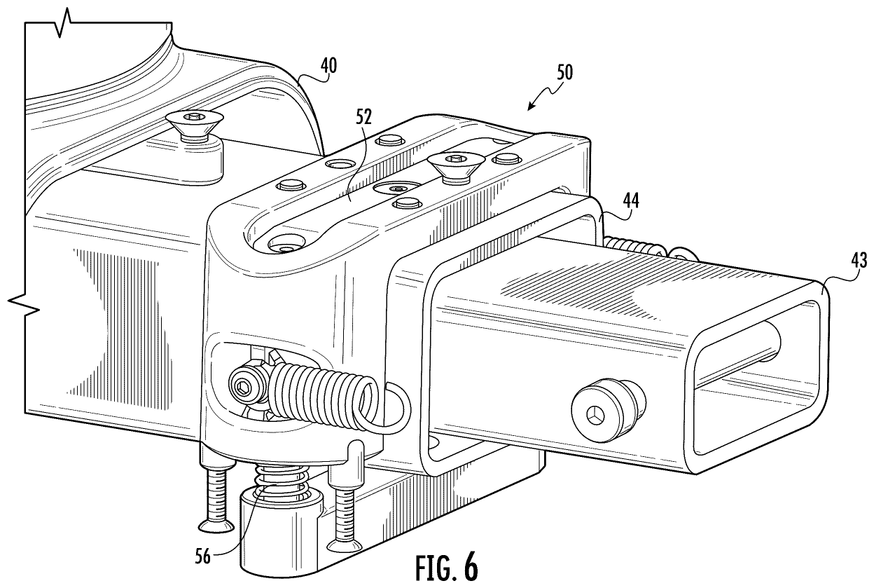

As may be appreciated in FIG. 5, the retaining assembly 30 may comprise a housing 40 with a first or right side 41 and a second or left side 42. Retaining structures 45 (e.g. grasping arms) may be disposed at opposite ends of the housing 40 and may be configured to extend outward and inward. For example, as is perhaps best shown in FIG. 6, channels 43 and 44 may be disposed within the housing 40 and may be configured and dimensioned to horizontally move with respect to one another. The retaining structures 45 may connected to corresponding ends of the channels 43 and 44, e.g., around an upper portion 46 thereof, and may be configured to reciprocally move with them. As such, channels 43 and 44 may collectively define a telescopic connection that can extend away from the center of the housing 40 towards its sides. As an example, channels 43 and 44 may comprise a substantially rectangular cross section, with channel 43 comprising a smaller cross section than that of channel 44. Also, both channels 43 and 44 may substantially define a slidable relation between them to enable the telescopic connection described above.

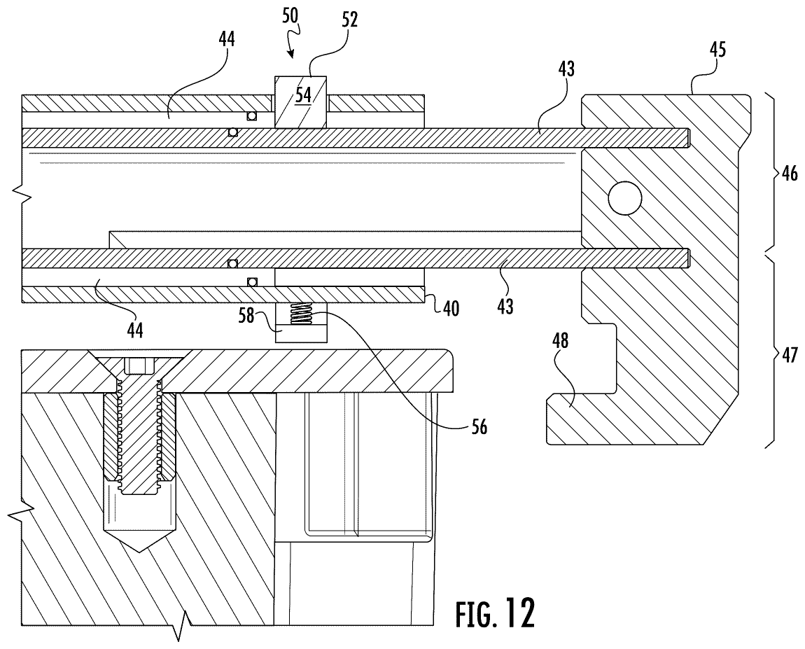

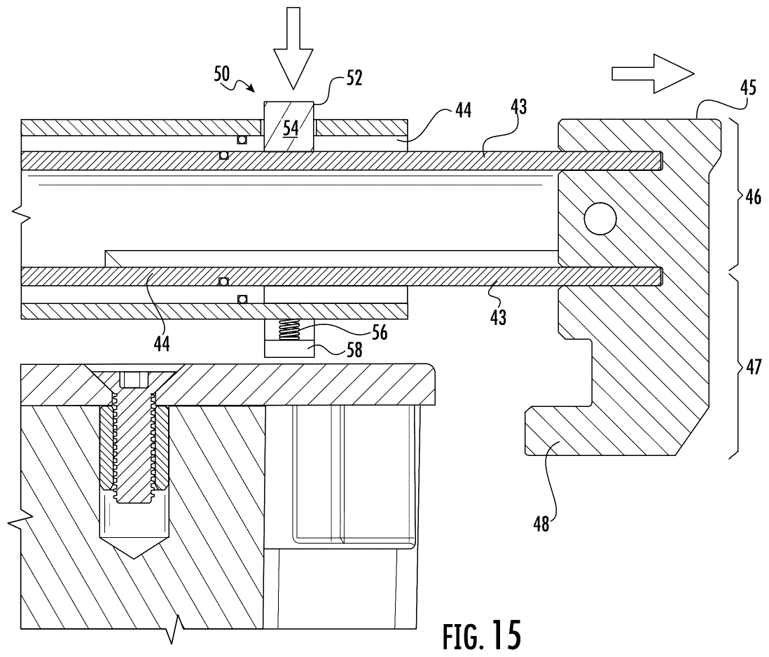

As a further example, channel 43 and its corresponding retaining structure 45, may extend away from the center of the housing 40, for example, from the position as shown in FIGS. 4-5 and 13-14, which is a “closed orientation”′ of the retaining assembly 30 to the position as shown in FIGS. 12 and 15, which is an “open orientation” of the retaining assembly 30, and vice versa. Similarly, channel 44, and consequently its retaining structure 45, may extend towards the left and away from the center of the housing 40, from the closed orientation, e.g. as shown in FIGS. 4-5 to the open orientation, and vice versa.

Additionally, visual indicators 49 may be adjacently disposed to the retaining structures 45 and may be configured to indicate, e.g., through a color scheme, when the retaining assembly 30 is disposed in the closed position and/or an intended item is securely retained, or when the retaining assembly 30 is disposed in the open position and the intended package is not securely retained. For example, the visual indicators 49 may display a green light indicating to the user that an intended package can be safely moved or a red light indicating that it is not advisable to move the intended package, e.g., if the retaining assembly 30 is in the open orientation or if the retaining assembly did not securely retain the intended item and it is not safe or advisable to move it.

Furthermore, it is contemplated that both channels 43 and 44 may be structured to move simultaneously. As such, and as will be explained hereinafter, a user may selectively expand channels 43 and 44 to define the open orientation or may selectively retract them to define the closed orientation. As contemplated by the present invention, a user may dispose the retaining assembly 30 in the “open orientation” before retaining an intended item, e.g., as shown in FIG. 12.

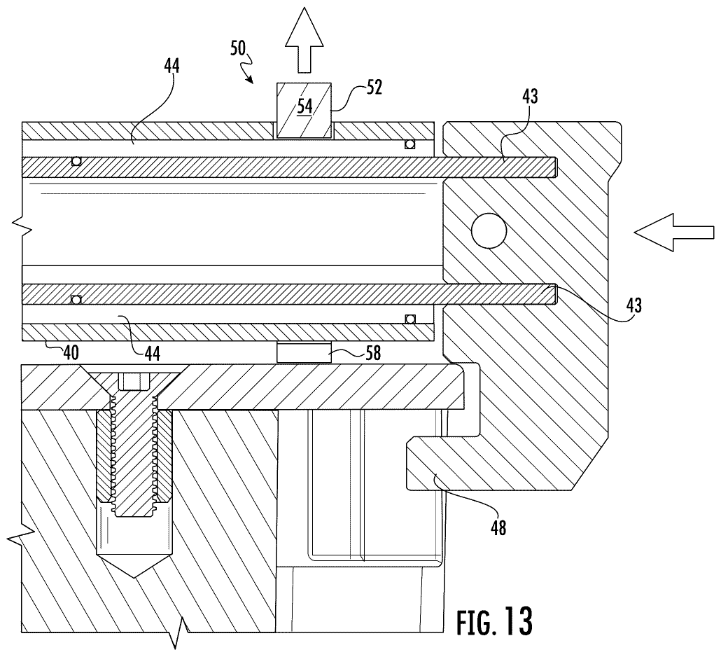

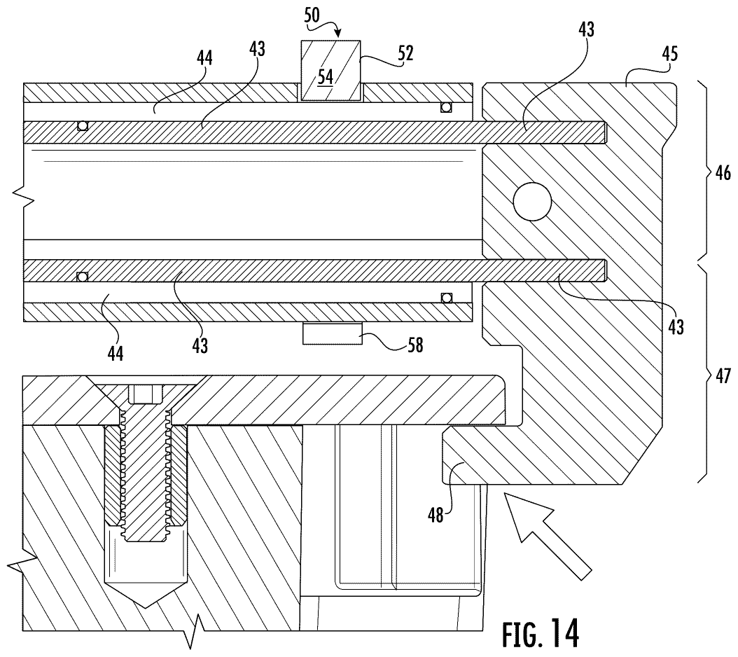

As shown in FIGS. 13-14, the user may thereafter dispose the retaining assembly 30 in the “closed orientation” after retaining the intended item, e.g., FIGS. 13-14. Additionally, and with reference to FIG. 6, the channels 43 and 44 may be operatively configured or otherwise interconnected to a plurality of horizontally disposed biasing structures 56, which by default maintain the retaining assembly 30 in the closed orientation, i.e., which pull the channels 43 and 44 inward. That is, an inward movement of channel 43 should be reciprocated with an inward movement of channel 44, and vice versa.

Also, an outward movement of channel 43 should be reciprocated with an outward movement of channel 44, and vice versa. Thus both channels 43, 44 should move together in the outward direction and in the inward direction. For example, and as shown in the illustrative embodiment of FIGS. 16-17 and 19, a gear or other analogous structure, which is indicated at 36, may be operatively connected with both channels 43 and 44, and may be configured to rotate in a clockwise and counter-clockwise direction within the housing 40. As such, a rotation of the gear 36 in one direction may result in the channels 43 and/or 44 simultaneously moving in an outward direction, i.e., away from the center of the housing 40. Conversely a rotation of the gear 36 in an opposite direction, may result in the channels 43 and 44 simultaneously moving in an inward direction, i.e., towards the closed orientation.

With reference to at least FIGS. 6-7 and 12-17, the lift-arm assembly 1 according to the present invention may be provided with a mechanism that automatically disposes the retaining assembly 30 from the open orientation and into the closed orientation upon contact with the intended package. For example, a locking assembly 50 may be operatively disposed within the housing 40 and may be structured to selectively dispose the retaining assembly 30 from the open orientation to the closed orientation.

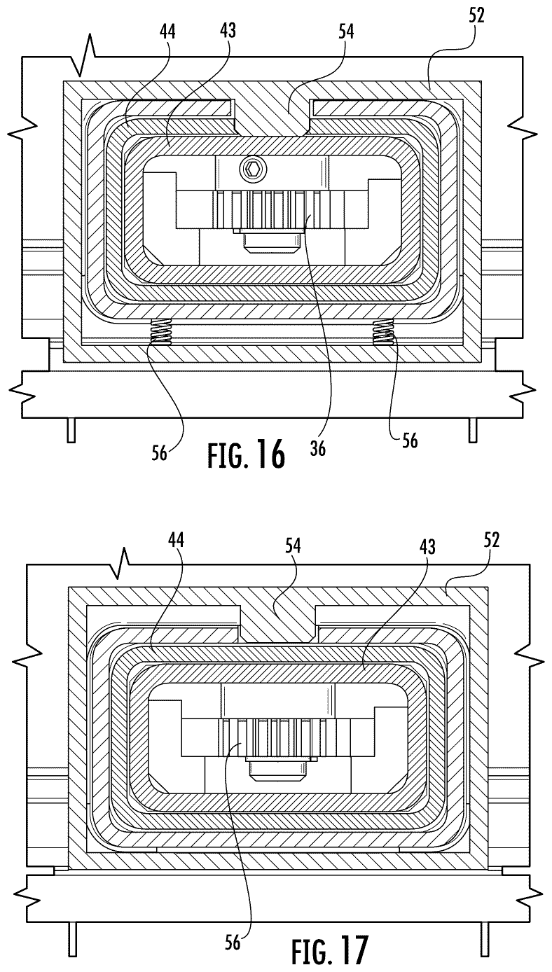

As may be best appreciated in FIGS. 16-17, the lift-arm assembly 1 may be provided with a bracket 52 that is at least partially disposed within the housing 40 and that is configured to move upward and downward within the housing 40 and/or relative to the channels 43 and/or 44. Also with reference to FIGS. 15-17, the top side of the bracket 52 may be provided with a locking structure 54, which is generally configured to move between a downward position, e.g., FIG. 16, and an upward position, e.g., FIG. 17.

In the downward position, which corresponds to the embodiment as shown in FIG. 12, the locking structure 54 may comprise a pin or may otherwise act as a retaining mechanism that prevents a full inward movement of channel 44, and consequently a corresponding full inward movement of channel 43. As such, the locking structure 54 is configured to act as a retaining mechanism that locks the channels 44 and/or 43 in an expanded position relative to the center of the housing 40, thereby maintaining the retaining assembly 30 in the open orientation. Thus, when the locking structure 54 is disposed in the downward position, the retaining assembly 30 is disposed in the open orientation.

Furthermore, vertical biasing structures 56 may be provided so that the bracket 52 and locking structure 54 normally assume the downward position maintaining the retaining assembly 30 in the open orientation by default. For example, as shown in the illustrative embodiment of FIG. 15, the vertical biasing structure(s) 56 is generally configured to push or otherwise depress a protrusion 58 or bottom side of the bracket 50 downward thereby resulting in a reciprocal downward movement of the locking structure 54.

With reference now to FIG. 13, once an intended item or portion thereof such as a cover, comes into contact with the bracket 52, e.g., around a protrusion 58 or bottom side thereof, the locking structure 54 may move in the upward direction and may release channel 44 such that it may continue its natural motion within the housing 40 towards a collapsed position, i.e., the closed orientation. Similarly, once the protrusion 58 is engaged or otherwise comes into contact with the intended item, channel 43 will also be automatically released such that it may simultaneously continue its natural motion within the housing towards the closed orientation.

As depicted in FIG. 12, vertical biasing structure(s) 56 may be configured such that it can provide at least a minimal resistance that may maintain the upward position by default. However, the vertical biasing structure(s) 56 should also be configured such that the locking structure 54 is release upon the intended item coming into contact with the protrusion 58.

The present invention contemplates that the intended item should be able to push the bracket 52 in the upward direction upon contact by creating at least a minimum upward force that is sufficient to release overcome the frictional resistance created between channel 44 and the locking structure 54. As such, once an intended item is engaged, e.g., as shown in FIG. 13, the retaining assembly 30 may be manually moved in the upward and/or horizontal direction from the pick-up position to a drop off position.

As represented in FIG. 14, during transport of the intended item, a lower portion 47 of the retaining structure 45 may be configured to retain the intended item. For example, the retaining structure(s) 45 may comprise an inward facing extended segment 48 that may be configured to retain the intended item around its underside or around an underside of a cover thereof. Other configurations of the retaining structure 45 are also possible and may include various other mechanisms or structures configured to retain or otherwise hold the intended item. Thus when an intended item(s) fully come into contact with the underside of the housing 40, and more specifically the protrusion, channels 43 and 44 automatically close such that the retaining structures 45 can secure the intended item(s).

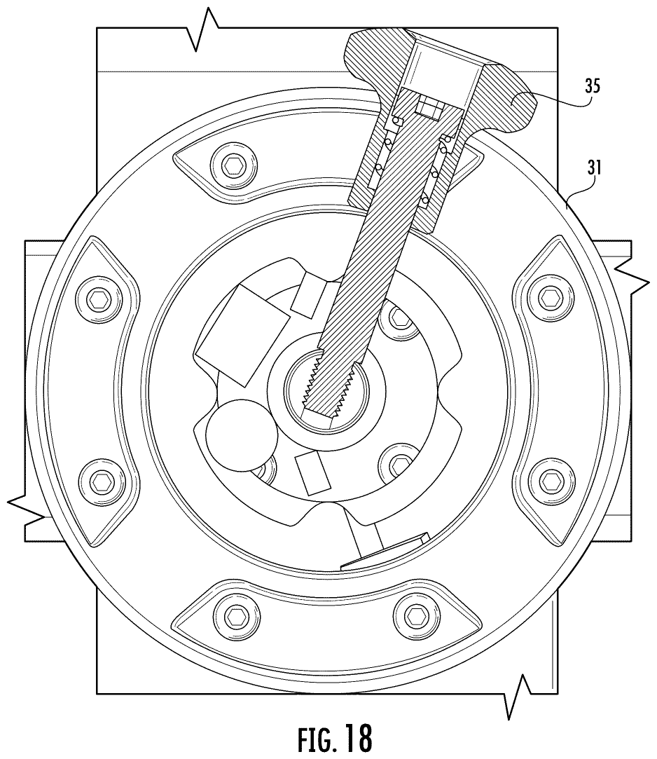

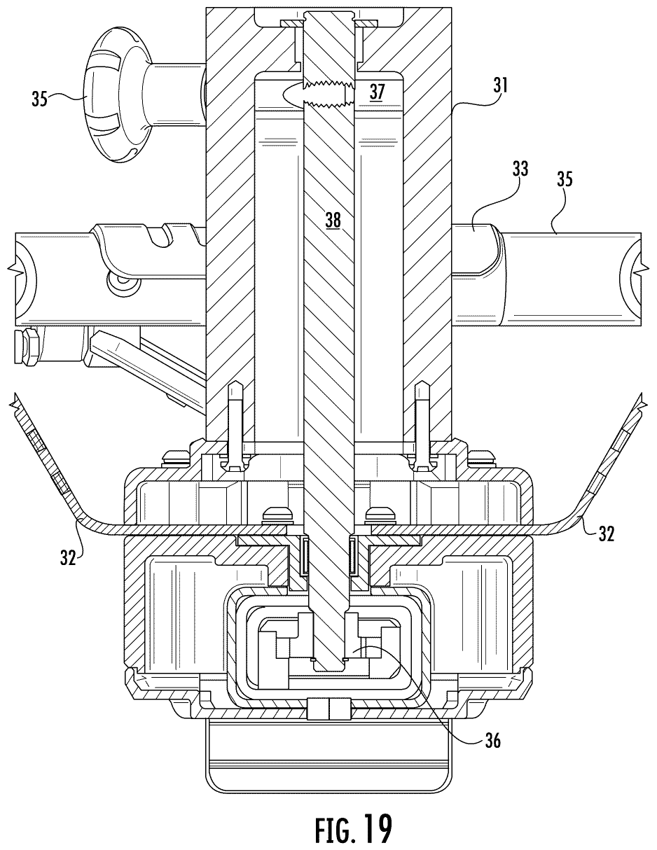

With reference to at least FIGS. 18-19, additional features of the present invention comprise providing a lift-arm assembly 1 with a manual override mechanism that can be used to selectively place the retaining assembly 30 in open orientation. Sometimes it may be necessary or desirable to dispose the retaining assembly 30 in the open orientation, for example, to release the intended item at a drop off location.

For example, as depicted in FIG. 19, an internal pin 38 may be disposed within the interior of the second vertical support 31 and/or the interior of the housing 40. The internal pin 38 may be operatively connected to a rotating lever 35, which may be structured to horizontally pivot around a groove 37, and which is substantially defined or otherwise formed along the wall of the second vertical support 31. For example, a user may manually rotate lever 35 approximately 90 degrees around the horizontal plane. The internal pin 38 may also be operatively connected to the gear 36 such that a rotation of the pin should result in a corresponding rotation of the gear 36.

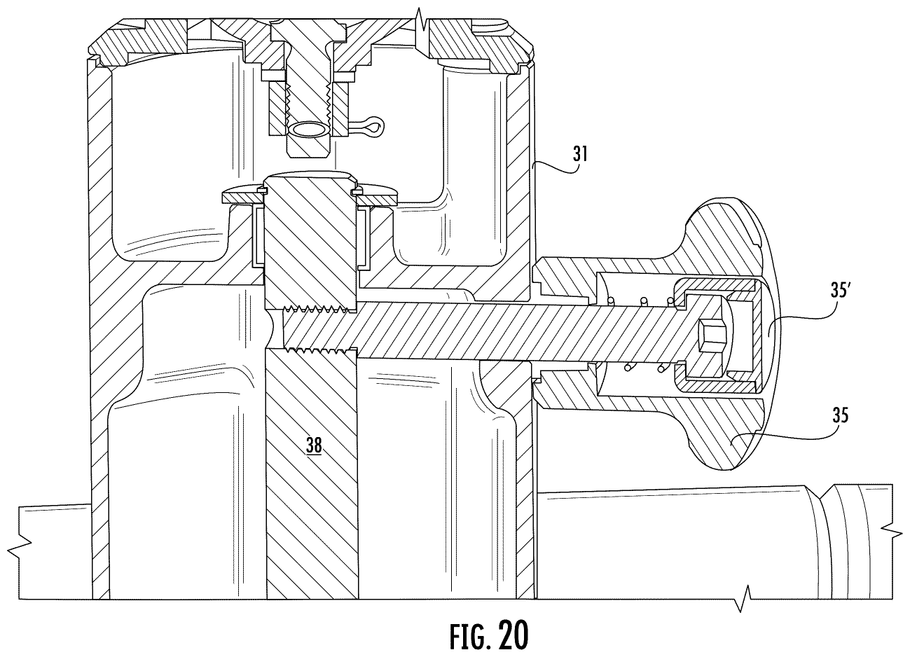

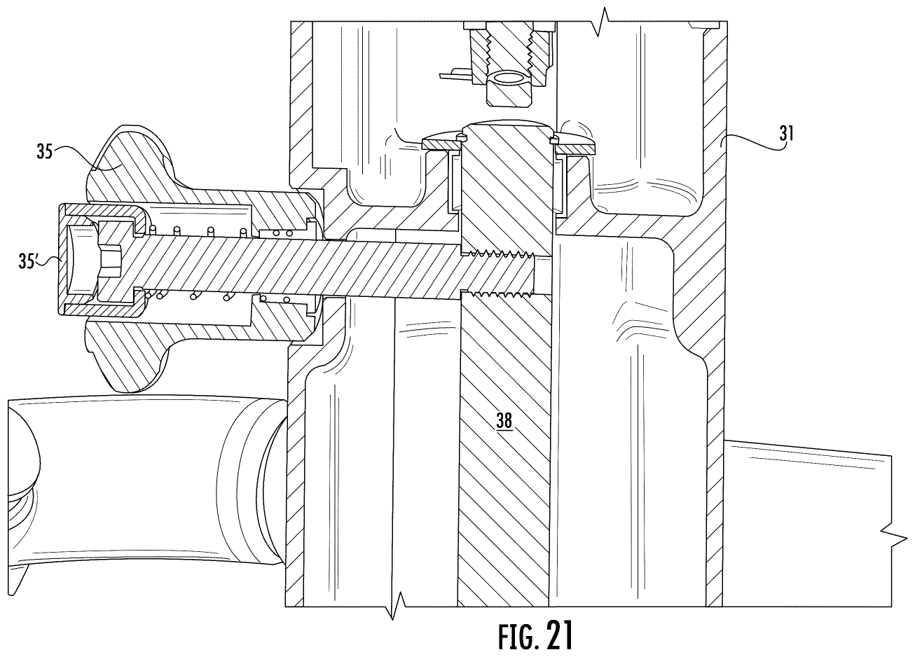

Accordingly, a manual rotation of the rotating lever 35 should result in a corresponding manual rotation of the internal pin 38 and consequently the gear 36, which places the retaining assembly 30 in the open orientation. Further, the rotating lever 35 may also comprise an indicator 35′, i.e., a button, knob or other related component, that can protrude outward when the retaining assembly 30 is disposed in the closed orientation, e.g., as shown in FIG. 21, or that can be retracted when the retaining assembly 30 is disposed in the open orientation, e.g., as shown in FIG. 20.

Additionally, once the retaining assembly 30 is disposed in the closed orientation, the rotating lever 35 should also go back to its initial position so that the user may selectively rotate it to manually release the retaining assembly 30 and manually dispose it into the open orientation. It is contemplated that a user will need to apply a force to the rotating lever 35 that is sufficient to overcome the resistance of the horizontal biasing structures 56, which by default pull the channels 43 and 44 towards one another.

Said differently, a user will need to apply a sufficient force to the rotating lever 35 in order to expand channels 43 and 44 and dispose the retaining assembly 30 in the open orientation and so that a user may manually lower it in position onto the intended item.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A counterbalancing lift-arm assembly comprising:
a support assembly including a vertical support and a base;
a position adjustment assembly connected to the support assembly and configured to enable vertical movement; and
a retaining assembly connected to the position adjustment assembly and configured to retain an item,
wherein the lift-arm assembly includes at least one counterbalancing mechanism configured to reduce the physical force required to move the retaining assembly.

2. The counterbalancing lift-arm assembly of claim 1, wherein the support assembly includes a sleeve rotatably mounted around the vertical support and a first horizontal support connected to the sleeve.

3. The counterbalancing lift-arm assembly of claim 1, wherein the position adjustment assembly includes a housing containing a motion control cylinder and a spring.

4. The counterbalancing lift-arm assembly of claim 1, wherein the counterbalancing mechanism comprises a pneumatic motion control cylinder configured to exert an upward force on the position adjustment assembly.

5. The counterbalancing lift-arm assembly of claim 1, wherein the support assembly includes at least one horizontal pivotal connection and one vertical pivotal connection configured to allow multidirectional manual movement of the retaining assembly.

6. The counterbalancing lift-arm assembly of claim 1, further comprising a resting clip connected to the base and configured to secure the retaining assembly in a non-operational position.

7. The counterbalancing lift-arm assembly of claim 6, wherein the resting clip includes a visual indicator configured to indicate whether the retaining assembly is secured.

8. A counterbalancing lift-arm system comprising:
a support structure connected to a position adjustment assembly;
a motion control cylinder operatively associated with the position adjustment assembly and configured to apply an upward force thereto;
a handle bar having at least one grab handle and at least one handle lever;
and a tensioning element operatively connecting the handle lever to the motion control cylinder,
wherein actuation of the handle lever enables vertical movement of the position adjustment assembly, and release of the handle lever restricts vertical movement.

9. The system of claim 8, wherein the handle bar includes two grab handles, each with a corresponding handle lever.

10. The system of claim 8, wherein the motion control cylinder is maintained in a locked state when the handle lever is not actuated.

11. The system of claim 8, wherein actuation of either one of the two handle levers enables vertical movement of the position adjustment assembly.

12. The system of claim 8, further comprising a cable connected between the handle lever and the motion control cylinder.

13. The system of claim 8, wherein the position adjustment assembly remains horizontally movable when in the locked state.

14. A retaining mechanism for a counterbalancing lift-arm assembly comprising:
a housing;
a first channel and a second channel disposed within the housing and configured to move laterally;
a pair of retaining structures connected to the respective channels;
a locking mechanism configured to hold the channels in an open orientation by default;
a contact-activated release configured to release the locking mechanism when an item contacts a bracket associated with the locking mechanism;
and a manual override mechanism configured to selectively move the channels to the open orientation.

15. The retaining mechanism of claim 14, wherein the channels are biased toward a closed orientation by horizontally disposed springs.

16. The retaining mechanism of claim 14, wherein the locking mechanism includes a bracket biased downward by a vertical spring and a locking pin disposed on a top side of the bracket.

17. The retaining mechanism of claim 14, wherein the manual override mechanism comprises a rotating lever operatively connected to a gear, the gear coupled to both the first and second channels.

18. The retaining mechanism of claim 17, wherein the rotating lever is mounted to a vertical support and pivots within a groove defined in the support.

19. The retaining mechanism of claim 17, further comprising a visual indicator associated with the rotating lever, wherein the indicator protrudes in the closed orientation and retracts in the open orientation.

20. The retaining mechanism of claim 14, further comprising visual indicators adjacent to the retaining structures, wherein the indicators display different colors corresponding to the open or closed orientation.
